(19) United States
(12) Patent Application Publication
(10) Pub. No.: US 2026/0086246 A1
(43) Pub. Date: Mar. 26, 2026

(54) METHOD FOR NETWORK-WIDE FIXING OF WIDELANE AMBIGUITIES BASED ON IONOSPHERIC CORRELATION, APPARATUS, AND SYSTEM

(71) Applicants: CHINA THREE GORGES CORPORATION, Wuhan (CN); THREE GORGES GROUP INDUSTRIAL DEVELOPMENT (BEIJING) CO., LTD., Beijing (CN)

(72) Inventors: Tingyan LV, Wuhan (CN); Jingliang ZHOU, Wuhan (CN); Rui ZHANG, Wuhan (CN); Jiaqi LIU, Wuhan (CN); Yuan CHEN, Guangzhou City (CN); Wei JIANG, Wuhan (CN); Shuiling XIONG, Wuhan (CN); Linchao HUANG, Guangzhou City (CN)

(73) Assignees: CHINA THREE GORGES CORPORATION, Wuhan, HB (CN); THREE GORGES GROUP INDUSTRIAL DEVELOPMENT (BEIJING) CO., LTD., Beijing (CN)

(21) Appl. No.: 19/277,473

(22) Filed: Jul. 23, 2025

(30) Foreign Application Priority Data
Sep. 24, 2024 (CN) 202411328491.2

(51) Int. Cl. G01S 19/23; G01S 19/37

(52) U.S. Cl. CPC G01S 19/23; G01S 19/37

(57) ABSTRACT

A method, apparatus, and system are disclosed for network-wide fixing of widelane ambiguities based on ionospheric correlation. The method involves: dividing a continuous operational reference system (CORS) network into ambiguity calculation units; collecting four or more groups of fixed widelane ambiguities within these units; constructing a regional ionospheric delay model; and judging false fixes against this model. If fewer than four groups of remaining widelane ambiguity data exist, the process exits. Alternative widelane ambiguity values and corresponding widelane ionospheric delays are then calculated. Finally, it's determined if these alternative values meet a judgment condition. Ionospheric delays corresponding to unfixed widelane ambiguities are interpolated via spatial correlation, using fixed widelane ambiguities within the CORS region. This enables fixing remaining unfixed widelane ambiguities using larger wavelength widelane observed values and verifies correctly fixed widelane ambiguities.

### TECHNICAL FIELD

The present disclosure relates to the technical field of remote sensing disaster identification, and in particular to, a method for network-wide fixing of widelane ambiguities based on ionospheric correlation, an apparatus, and a system.

### BACKGROUND OF THE INVENTION

Ambiguity fixing between reference stations of GNSS is the basis of network PTK positioning. Due to a relatively long distance between reference stations of zonal CORS, influences of ionospheric delays and tropospheric delays cannot be neglected. Ambiguities are often estimated and fixed by an ionosphere-free combination or by way of adding ionospheric constraints. Blewitt and Geoffrey introduced an ambiguity fixing method for a middle- and long-distance static baseline in detail in 1989. By adopting the ionospheric layer-free combination, the method is specifically divided into three steps: I, a widelane integer ambiguity is estimated and fixed, where by adopting a Hatch-Melbourne-Wübbena combined observed value that is a geometrical distance-free combination, many error influences such as errors of coordinates of observation stations may be avoided and the method is just affected by observed value noise, multi-path delays, and delay errors of satellites and receiver hardware. II, the influence of the ionospheric delay is eliminated by means of the ionospheric delay-free combination, and meanwhile, zenithal tropospheric wet delays are estimated to subtract the influence of the tropospheric delay on solution, and a carrier ambiguity float solution of the ionospheric delay-free combination is estimated. III, a narrow lane ambiguity float solution and precision thereof are calculated by means of fixed widelane ambiguities and the ambiguity float solution of the ionospheric delay-free combination and precision thereof, and ambiguity fixing is performed. In order to accelerate fast fixing of ambiguities, since the 1990s, a series of fast ambiguity fixing methods have been proposed. Chu proposed a method for fixing ambiguities between reference stations based on triple-frequency data in 2016. This method first fixes ultrawidelane ambiguities by means of pseudorange observed values, and then fixes widelane ambiguities by means of the fixed ultrawidelane ambiguities to further solve and fix triple-frequency ambiguities. Zhang proposed a method for fixing ambiguities between reference stations by means of an ionospheric constraint model in 2017. This method constrains ionospheric delay parameters by means of mutual relations of peripheral ionospheric delays to further resolve the ambiguities between the reference stations.

To sum up, although there have been many research achievements for resolving ambiguities between reference stations, and atmospheric interpolation models in medium- and small-regions are essentially weighted averages of atmospheric information of baselines or base stations, existing models have been able to fit regional atmospheric changes in a calm period well. However, when the atmospheric environment is active, atmospheric delay errors still greatly affect the solution process of regional enhanced positioning users, resulting in that the above research achievements landed on network RTK software cannot gain better application effects. Meanwhile, existing research does not sufficiently utilize the special conditions of network RTK application scenarios. Therefore, it is necessary to make full use of all favorable conditions to further improve the method for fixing ambiguities between reference stations and enhance the network RTK positioning effect.

### SUMMARY OF THE INVENTION

The present disclosure provides a method for network-wide fixing of widelane ambiguities based on ionospheric correlation, an apparatus, and a system. The corresponding ionospheric delays are calculated by means of a plurality of widelane ambiguities that have been fixed in the CORS region, and the ionospheric delays corresponding to unfixed widelane ambiguities are interpolated by means of spatial correlation of the ionospheric delays, so that remaining unfixed widelane ambiguities are fixed by means of larger wavelengths widelane observed values, and whether the fixed widelane ambiguities are fixed correctly may also be checked.

To solve the above technical problem, the present disclosure adopts the following technical solution:

A method for network-wide fixing of widelane ambiguities based on ionospheric correlation includes the following steps:
Step 1, dividing all base stations in a continuous operational reference system (CORS) network into a plurality of independent ambiguity calculation units by means of superposed ionospheric pierce points;
Step2, collecting four or more groups of fixed widelane ambiguities in each of the ambiguity calculation units;
Step3, calculating widelane ionospheric delays corresponding to each group of widelane ambiguities collected to construct a regional ionospheric delay model;
Step4, judging whether the widelane ambiguities are fixed falsely according to the regional ionospheric delay model, if the widelane ambiguities are fixed falsely, eliminating the falsely fixed widelane ambiguities, judging whether no fewer than four groups of remaining widelane ambiguity data are present, and if no fewer than four groups of remaining widelane ambiguity data are present, repeatedly executing Step3; and if fewer than four groups of remaining widelane ambiguity data are present, exiting a calculation process;
Step5, if no false fixing is found in a process of judging false fixing of widelane ambiguities in Step4, continuously judging whether unfixed widelane ambiguities exist in a current ambiguity calculation unit, and if the unfixed widelane ambiguities exist in the current ambiguity calculation unit, interpolating widelane ionospheric delays corresponding to the unfixed ambiguities by means of the regional ionospheric delay model in Step3, and calculating alternative values of the widelane ambiguities and widelane ionospheric delays corresponding to the alternative values; and
Step6, viewing whether the alternative values of the widelane ambiguities calculated in Step5 meet a judgment condition, if yes, adding the alternative values into Step3 to iteratively construct the regional ionospheric delay model, and if no, returning to Step5 to perform calculations of the widelane ambiguities again.

A specific process of Step1 is as follows:
a specific judgment formula for ionospheric pierce points is as follows:

$$\{ \begin{matrix}\vert {ϕ}_{{IPP}_{r}} - {ϕ}_{{IPP}_{m}} \vert < M \\ \vert \frac{{θ}_{{IPP}_{r}}}{cos {ϕ}_{{IPP}_{r}}} - \frac{{θ}_{{IPP}_{m}}}{cos {ϕ}_{{IPP}_{m}}} \vert < N\end{matrix} ; \qquad ( 1 )$$

where Ø_{IPP}_{ᵣ} and θ_{IPP}_{ᵣ} are respectively latitudes and longitudes of the ionospheric pierce points corresponding to a base station r; M and N are judgment thresholds, and by judging whether the ionospheric pierce points are superposed ionospheric pierce points, all base stations in the CORS network are divided into the plurality of independent ambiguity calculation units, ensuring that the ionospheric pierce points of each of the base stations in a same calculation unit are superposed.

A specific process of Step2 is as follows:
first, attempting to perform ambiguity fixing on each satellite-base station combination in each of the ambiguity calculation units, and if ambiguities cannot be completely fixed, using a partial ambiguity fixing method to increase the ambiguity fixing quantity, the partial ambiguity fixing method just fixes ambiguities of a part of baselines rather than ambiguities of all baselines; then, calculating residual errors and variances of a satellite-base station observed value model with fixed ambiguities and distributing the residual errors and the variances to other variable portions containing to-be-evaluated parameters according to the law of error propagation, and taking out the residual errors and the variances of an ionospheric correlated portion; and finally, selecting the residual errors of the ionospheric correlated portion for sequencing, and selecting widelane ambiguities with smallest variances in order for fixing, and then applying the widelane ambiguities to subsequent calculations.

A specific process of Step3 is as follows:
first, processing baselines of the fixed widelane ambiguities to acquire approximate ionospheric delays of the baseline, extracted based on the widelane ambiguities, i.e., the widelane ionospheric delays ∇ΔI_{WL}, a calculation formula therefor being as follows:

$${λ}_{WL}^{i} ( ∇ {Δφ}_{WL , rm}^{ij} + ∇ Δ {N}_{WL , rm}^{ij} ) = ∇ {Δρ}_{rm}^{ij} - \frac{{f}_{1}}{{f}_{2}} ∇ Δ I + [ ( {m}_{r}^{i} - {m}_{r}^{j} ) {T}_{r} - ( {m}_{m}^{i} - {m}_{m}^{j} ) {T}_{m} ] + ∇ {Δγ}_{rm}^{ij} + ε ( {φ}_{rm}^{ij} ) \qquad ( 2 )$$

$$\begin{matrix}∇ Δ {I}_{WL} = ∇ Δ I - \frac{{f}_{2}}{{f}_{1}} [ ∇ {Δγ}_{rm}^{ij} + ε ( {φ}_{rm}^{ij} ) ] \\ = \frac{{f}_{2}}{{f}_{1}} \{ - {λ}_{WL}^{i} ( ∇ {Δφ}_{WL , rm}^{ij} + ∇ Δ {N}_{WL , rm}^{ij} ) + ∇ {Δρ}_{rm}^{ij} + [ ( {m}_{r}^{i} - {m}_{r}^{j} ) {T}_{r} - ( {m}_{m}^{i} - {m}_{m}^{j} ) {T}_{m} ] \}\end{matrix} ;$$

where

$${λ}_{WL}^{i}$$

represents a double difference widelane carrier observed value;

$$∇ {Δφ}_{WL , rm}^{ij}$$

represents a double difference widelane carrier observed value;

$$∇ Δ {N}_{WL , rm}^{ij}$$

is a known double difference widelane ambiguity fixing solution;

$$∇ {Δρ}_{rm}^{ij}$$

is a double difference satellite-to-earth distance that is calculable; f₁ and f₂ represent a first frequency point frequency and a second frequency point frequency; ΛΔI is a double difference ionospheric delay of a carrier observed value of L1, L1 being a first frequency point of an observed value of a GPS system, with a frequency of 1575.42 MHz;

$${m}_{r}^{i} , {m}_{r}^{j} , {m}_{m}^{i} , and {m}_{m}^{j}$$

respectively represent tropospheric projection function values of delay errors between observation stations r and m and satellites i and j; Tᵣ and Tₘ represent tropospheric delays above the observation stations r and m, calculated by a high-precision empirical model;

$$∇ {Δγ}_{WL , rm}^{ij}$$

represents a delay error of double difference carrier hardware; and

$$ε ( {φ}_{rm}^{ij} )$$

represents noise of the carrier observed value; and
extracting widelane ionospheric delays corresponding to the baselines of the fixed widelane ambiguities through formula (2) to construct the regional ionospheric delay model, a formula being as follows:

$$V = BX - L ;$$

where V represents a residual matrix between the widelane ionospheric delay model and an actual observed value, B is a model design matrix, X is a to-be-evaluated model parameter matrix, L is an actual observed value matrix, ΔX₁ and ΔY₁ are an eastern distance and a northern distance from each point of a topocentric coordinate system of baseline 1 to a reference point, ΔX₂ and ΔY₂ are an eastern distance and a northern distance from each point of a topocentric coordinate system of baseline 2 to a reference point, and ΔXₙ and ΔYₙ are an eastern distance and a northern distance from each point of a topocentric coordinate system of baseline n to a reference point, meeting:

$$B = [ \begin{matrix}Δ {X}_{1} & Δ {Y}_{1} \\ Δ {X}_{2} & Δ {Y}_{2} \\ ⋮ & ⋮ \\ Δ {X}_{n} & Δ {Y}_{n}\end{matrix} ] ;$$

$$X = [ \begin{matrix}{a}_{1} \\ {a}_{2}\end{matrix} ] ;$$

where a₁ and a₂ are corresponding interpolation coefficients; and

$$L = [ \begin{matrix}∇ Δ {I}_{WL 1} \\ ∇ Δ {I}_{WL 2} \\ ⋮ \\ ∇ Δ {I}_{WLn}\end{matrix} ] ,$$

A specific process of Step4 is as follows:
upon completion of constructing the regional ionospheric delay model, due to redundant observations, checking the residual errors of the observed value model, checking indexes being as follows:

$$\{ \begin{matrix}\begin{matrix}\vert {V}_{i} \vert < 0.3 \cdot μ & i = 1 , 2 , … n\end{matrix} \\ \sqrt{\frac{{V}^{T} \cdot V}{n}} < 0.2 \cdot μ\end{matrix}$$

$$μ = {λ}_{WL} \cdot \frac{{f}_{2}}{{f}_{1}} ;$$

where Vᵢ represents an i^{th} residual error, λ_{WL} represents a wavelength of the widelane carrier observed value, V^{T} is a transposed vector of the residual matrix, and μ is a widelane ionospheric delay variation induced by widelane ambiguity fixing for one cycle, and is derivable from the formula in Step3; and
if the residual errors exceed a limit, eliminating a maximum value of the residual errors, performing remodeling till residual checking passes or fewer than four available baselines are present.

In the Step5, after residual examination, widelane ionospheric interpolated values of remaining unfixed baselines are calculated by means of the following formula, and the interpolated values represent widelane ionospheric results of a to-be-calculated point estimated by means of the known widelane ionospheric result:

$$∇ {M}_{WL - IPv} = {a}_{1} \cdot Δ {X}_{v} + {a}_{2} \cdot Δ {Y}_{v} ;$$

where ΛΔI_{WL-IPv} is an unfixed double difference ionospheric delay on baseline v, ΔXᵥ and ΔYᵥ respectively represent the eastern distance and northern distance from each point of a topocentric coordinate system of baseline v to the reference point, baselines with unfixed widelane ambiguities are checked and judged one by one, by taking a nearest integer of a float solution of widelane ambiguities as a center, the float solution is expanded for two or three cycles respectively toward two ends to obtain a plurality of alternative integer solutions, the alternative integer solutions are respectively substituted into Step3 to calculate corresponding widelane ionospheric delays, respectively, and when the widelane ionospheric delay of a certain alternative point meets a judgment condition in the following formula, the ambiguity is directly fixed:

$$\vert ∇ Δ {I}_{WL - IPv} - ∇ Δ {I}_{W L v} \vert < 0.3 \cdot μ ;$$

where ΛΔI_{WLv} is a double difference ionospheric delay calculated according to the alternative integer solutions.

In the Step6, ionospheric delay observed values with the fixed widelane ambiguities of all station sites in a current epoch are collected, and model calculated values of the regional ionospheric delay model at the observation sites are calculated, an error mean value and a standard difference of a current model are calculated by means of a difference value between the output results after model calculation and the observed values, then, when the alternative values meet the judgment condition, first, ionospheric delay values of regions where the alternative values are located are calculated by using the existing regional ionospheric delay model, and finally, whether a difference value between the alternative values and a regional ionospheric delay model value is less than three times of the standard difference is judged, if yes, the regional ionospheric delay model is iteratively constructed, and if no, it is returned to Step5 to perform widelane ambiguity fixing calculation again.

After Step6 is completed, with satellite motions, existing independent ambiguity calculation units will change, and when two independent ambiguity calculation units are mutually fused or the pierce points in one independent ambiguity calculation unit no longer meet the limiting condition in Step 1 and are split, the iterative regional ionospheric delay model should be calculated again according to Step1-Step6 by using the existing delay ionospheric model.

An apparatus using the method for network-wide fixing of widelane ambiguities based on ionospheric correlation includes:
a determination module, configured to divide all base stations in a continuous operational reference system (CORS) network into a plurality of independent ambiguity calculation units by means of superposed ionospheric pierce points; and collect four or more groups of fixed widelane ambiguities in each of the ambiguity calculation units;
a fixing module, configured to calculate widelane ionospheric delays corresponding to each group of widelane ambiguities collected to construct a regional ionospheric delay model;
judge whether the widelane ambiguities are fixed falsely according to the regional ionospheric delay model, if the widelane ambiguities are fixed falsely, eliminate the falsely fixed widelane ambiguities, judge whether no fewer than four groups of remaining widelane ambiguity data are present, and if no fewer than four groups of remaining widelane ambiguity data are present, repeatedly execute the previous step; and if fewer than four groups of remaining widelane ambiguity data are present, exit a calculation process; if no false fixing is found in a process of judging false fixing of widelane ambiguities, continuously judge whether unfixed widelane ambiguities exist in a current ambiguity calculation unit, and if the unfixed widelane ambiguities exist in the current ambiguity calculation unit, interpolate widelane ionospheric delays corresponding to the unfixed ambiguities by means of the regional ionospheric delay model, and calculate alternative values of the widelane ambiguities and widelane ionospheric delays corresponding to the alternative values; and
a modeling module, configured to view whether the alternative values calculated meet a judgment condition, if yes, iteratively construct the regional ionospheric delay model, and if no, perform widelane ambiguity fixing calculation again.

A system using the method for network-wide fixing of widelane ambiguities based on ionospheric correlation includes a processor, a memory, and a program for network-wide fixing of widelane ambiguities based on ionospheric correlation, that is, stored in the memory and executable by the processor, where when executed by the processor, the program for network-wide fixing of widelane ambiguities based on ionospheric correlation implements the steps of the method for network-wide fixing of widelane ambiguities based on ionospheric correlation.

According to the method for network-wide fixing of widelane ambiguities based on ionospheric correlation, the apparatus, and the system provided by the present disclosure, aiming at the problem that steps such as subsequent L1 ambiguity fixing and atmospheric error modeling will be adversely affected since the fixed rates of a part of widelane ambiguities in the region are low and existing widelane ambiguities may be fixed falsely, the present disclosure provides a method for network-wide fixing of widelane ambiguities based on ionospheric correlation. This method, based on the characteristic that ionospheric spaces in the pierce point superposing region are strongly correlated, may accurately and quickly fix all ambiguities in the calculation units by taking the ionospheric delays extracted by means of the widelane ambiguities as a medium. In the process of fixing a nearly million of widelane ambiguities, false fixing is avoided, all the ambiguities are basically fixed, and the unfixed rates are less than 0.1%. About two groups of BDS observed values are averagely increased in the regional enhanced correction numbers applying this method, and the average fixed rates of BDS, GPS, and GC combined positioning modes are increased over 10%, where the fixed rate corresponding to BDS single system positioning is increased by about 35%, and the positioning precision in the vertical direction is increased by over 30%. Therefore, based on this method, adverse influences caused by unfixed ambiguities or falsely fixed ambiguities may be basically avoided, thereby laying a good foundation for subsequent GNSS regional enhanced positioning.

### BRIEF DESCRIPTION OF DRAWINGS

The present disclosure will be further described with reference to the drawings and embodiments:

FIG. 1 is a schematic diagram of the distribution of local station sites of a CORS network in Embodiments of the present disclosure;

FIG. 2 is a comparison diagram of GPS PRN06 widelane ionospheric residual errors of GT14_GT18 baselines in Embodiments of the present disclosure;

FIG. 3 is a comparison diagram of GPS PRN06 widelane ionospheric posterior precisions in Embodiments of the present disclosure;

FIG. 4 is a comparison diagram of BDS positioning horizontal distributions of GT20 not using and using the present disclosure in Embodiments of the present disclosure;

FIG. 5 is a comparison diagram of BDS positioning vertical sequences of GT20 not using and using the present disclosure in Embodiments of the present disclosure;

FIG. 6 is a comparison diagram of GPS positioning horizontal distributions of GT20 not using and using the present disclosure in Embodiments of the present disclosure;

FIG. 7 is a comparison diagram of GPS positioning vertical sequences of GT20 not using and using the present disclosure in Embodiments of the present disclosure;

FIG. 8 is a comparison diagram of GC positioning horizontal distributions of GT20 not using and using the present disclosure in Embodiments of the present disclosure; and

FIG. 9 is a comparison diagram of GC positioning vertical sequences of GT20 not using and using the present disclosure in Embodiments of the present disclosure.

### DETAILED DESCRIPTION OF THE INVENTION

The technical solutions of the present disclosure will be described in detail below in conjunction with drawings and embodiments.

A method for network-wide fixing of widelane ambiguities based on ionospheric correlation includes the following steps:
Step 1, all base stations in a continuous operational reference system (CORS) network are divided into a plurality of independent ambiguity calculation units by means of superposed ionospheric pierce points;
Since the theoretical core of this method is the spatial correlation of the ionospheric delays, with the increase of the distance, affected by the ionospheric decorrelation effect and medium- and small-scale ionospheric disturbance, the spatial correlation of the ionospheric delays is reduced gradually. Therefore, determining the boundary is crucial to this method.

In order to determine the data selection and method coverage area, the concept of ionospheric pierce points, i.e., IPP superposition is introduced herein. In the course of processing the regional ionospheric delays, it is usually assumed that the ionospheric layer is a thin layer with uniform densities above the Earth, and the IPPs are intersection points between GNSS signal rays and the thin layer. By analyzing the total electron content, i.e., TEC data of the ionospheric layers of the GNSS reference stations distributed globally, when in a same epoch and the distances between two GNSS base stations and two IPPS of a same satellite are close enough, the electron density gradient in the ionospheric layer between the two IPPs is very small or have a linear function relationship with the distances between the IPPs, which indicates that the ionospheric spatial correlation between the IPP pairs is strong, and a better interpolation precision may be achieved. The two IPPs are defined as superposed IPPs. A specific judgment formula for the IPPs is as follows:

$$\{ \begin{matrix}\vert {ϕ}_{{IPP}_{r}} - {ϕ}_{{IPP}_{m}} \vert < M \\ \vert \frac{{θ}_{{IPP}_{r}}}{cos {ϕ}_{{IPP}_{r}}} - \frac{{θ}_{{IPP}_{m}}}{cos {ϕ}_{{IPP}_{m}}} \vert < N\end{matrix} ;$$

where Ø_{IPP}_{ᵣ} and θ_{IPP}_{ᵣ} are latitudes and longitudes of the ionospheric pierce points corresponding to a base station r; M and N are judgment thresholds, are usually set as 0.2o and 0.2o; since the change of the ionospheric delay gradient in the longitudinal direction is greater than that in the latitude direction, when [0.2o,0.2o] cannot be met, the judgment threshold in the latitude direction may be properly relaxed, i.e., [0.2o,0.4o] is used for judgment; and by judging whether the ionospheric pierce points are superposed ionospheric pierce points, all base stations in the CORS network are divided into the plurality of independent ambiguity calculation units, ensuring that the ionospheric pierce points of each of the base stations in a same calculation unit are superposed.

Step2, four or more groups of fixed widelane ambiguities in each of the ambiguity calculation units are collected;

As a supplementary method for fixing of widelane ambiguities, this method itself cannot independently fix widelane ambiguities, but is required to quickly and supplementarily fix remaining unfixed widelane ambiguities under the premise that widelane ambiguities of a part of station sites in the units. Therefore, this method requires to fix widelane ambiguities of a same satellite group by existing four stations or four baselines in the region. This is mainly to have redundant observed values to check the atmospheric model, so as to prevent the widelane integer ambiguity itself participating in modelling from being falsely fixed.

Step3, widelane ionospheric delays corresponding to each group of widelane ambiguities collected are calculated to construct a regional ionospheric delay model;
first, baselines of the fixed widelane ambiguities are processed to acquire approximate ionospheric delays of the baseline, extracted based on the widelane ambiguities, i.e., the widelane ionospheric delays Δ∇I_{WL}, a calculation formula therefor being as follows:

$${λ}_{W L}^{i} ( ∇ {Δφ}_{WL , rm}^{ij} + ∇ Δ {N}_{WL , rm}^{ij} ) = ∇ Δ {ρ}_{r m}^{ij} - \frac{{f}_{1}}{{f}_{2}} ∇ Δ I + [ ( {m}_{r}^{i} - {m}_{r}^{j} ) {T}_{r} - ( {m}_{m}^{i} - {m}_{m}^{j} ) {T}_{m} ] + ∇ {Δγ}_{r m}^{ij} + ε ( {φ}_{r m}^{ij} )$$

$$∇ Δ {I}_{W L} = ∇ Δ I - \frac{{f}_{2}}{{f}_{1}} [ ∇ {Δγ}_{r m}^{ij} + ε ( {φ}_{r m}^{ij} ) ] = \frac{{f}_{2}}{{f}_{1}} \{ - {λ}_{WL}^{i} ( ∇ {Δφ}_{WL , rm}^{ij} + ∇ Δ {N}_{WL , rm}^{ij} ) + ∇ Δ {ρ}_{r m}^{ij} + [ ( {m}_{r}^{i} - {m}_{r}^{j} ) {T}_{r} - ( {m}_{m}^{i} - {m}_{m}^{j} ) {T}_{m} ] \} ;$$

$$where {λ}_{W L}^{i}$$

represents a wavelength of a widelane carrier observed value;

$$∇ {Δφ}_{W L , r m}^{i j}$$

represents a double difference widelane carrier observed value;

$$∇ Δ {N}_{W L , r m}^{i j}$$

is a known double difference widelane ambiguity fixed solution; f₁ and f₂ represent a first frequency point frequency and a second frequency point frequency; ΛΔI is a double difference ionospheric delay of a carrier observed value of L1, L1 being a first frequency point of an observed value of a GPS system, with a frequency of 1575.42 MHz;

$${m}_{r}^{i} , {m}_{r}^{j} , {m}_{m}^{i} and {m}_{m}^{j}$$

respectively represent tropospheric projection function values of delay errors between observation stations r and m and satellites i and j; Tᵣ and Tₘ represent tropospheric delays above the observation stations r and m, calculated by a high-precision empirical model;

$$∇ Δ {γ}_{W L , r m}^{i j}$$

represents a delay error of double difference carrier hardware; and

$$ε ( {φ}_{r m}^{i j} )$$

represents noise of the carrier observed value;

$$Δ ∇ {ρ}_{r m}^{i j}$$

is a double frequency satellite-Earth distance that is accurately calculable; however, since it is unable to accurately calculate the multi-path errors and the unmodeled errors, ionospheric delays containing the multi-path errors and the unmodeled errors can be resolved by means of the fixed widelane ambiguities; due to the inaccurate ionospheric delays, the ionospheric layers are defined herein as approximate ionospheric delays extracted based on widelane ambiguities; to facilitate illustration, the ionospheric delays are abbreviated as widelane ionospheric delays subsequently;
widelane ionospheric delays corresponding to baselines of the fixed widelane ambiguities are extracted through the above formula to construct the regional ionospheric delay model, a formula being as follows:

$$V = B X - L ;$$

where I represents a residual matrix between the widelane ionospheric delay model and an actual observed value, B is a model design matrix, X is a to-be-evaluated model parameter matrix, L is an actual observed value matrix, ΔX₁ and ΔY₁ are an eastern distance and a northern distance from each point of a topocentric coordinate system of baseline 1 to a reference point, ΔX₂ and ΔY₂ are an eastern distance and a northern distance from each point of a topocentric coordinate system of baseline 2 to a reference point, and ΔXₙ and ΔYₙ are an eastern distance and a northern distance from each point of a topocentric coordinate system of baseline to a reference point, meeting:

$$B = [ \begin{matrix}Δ {X}_{1} & Δ {Y}_{1} \\ Δ {X}_{2} & Δ {Y}_{2} \\ ⋮ & ⋮ \\ Δ {X}_{n} & Δ {Y}_{n}\end{matrix} ] ;$$

$$X = [ \begin{matrix}{a}_{1} \\ {a}_{2}\end{matrix} ] ;$$

where a₁ and a₂ are corresponding interpolation coefficients; and

$$L = [ \begin{matrix}∇ Δ {I}_{WL 1} \\ ∇ Δ {I}_{WL 2} \\ ⋮ \\ ∇ Δ {I}_{W L n}\end{matrix} ] ,$$

Step4, whether the widelane ambiguities are fixed falsely is judged according to the regional ionospheric delay model, if the widelane ambiguities are fixed falsely, the falsely fixed widelane ambiguities are eliminated, whether no fewer than four groups of remaining widelane ambiguity data are present is judged, and if no fewer than four groups of remaining widelane ambiguity data are present, Step3 and Step4 are repeatedly executed; and if fewer than four groups of remaining widelane ambiguity data are present, a calculation process exits;
upon completion of constructing the regional ionospheric delay model, due to redundant observations, the residual errors of the observed value model are checked, checking indexes being as follows:

$$\{ \begin{matrix}\begin{matrix}\vert {V}_{i} \vert < 0.3 \cdot μ & i = 1 , 2 , … n\end{matrix} \\ \sqrt{\frac{{V}^{T} \cdot V}{n}} < 0.2 \cdot μ\end{matrix}$$

$$μ = {λ}_{W L} \cdot \frac{{f}_{2}}{{f}_{1}} ;$$

where Vᵢ represents an i^{th} residual error, λ_{WL} represents a wavelength of the widelane carrier observed value, V^{T} is a transposed vector of the residual matrix, and μ is a widelane ionospheric delay variation induced by false fixing of the widelane ambiguity or one cycle, and is derivable from the formula in Step3; and for the GPS system signal, the value is approximately 0.65 m;
if the residual errors exceed a limit, a maximum value of the residual errors is eliminated, remodeling is performed till residual checking passes or fewer than four available baselines are present.

Step5, if no false fixing is found in a process of judging false fixing of widelane ambiguities in Step4, whether unfixed widelane ambiguities exist in a current ambiguity calculation unit is continuously judged, and if the unfixed widelane ambiguities exist in the current ambiguity calculation unit, widelane ionospheric delays corresponding to the unfixed ambiguities are interpolated by means of the regional ionospheric delay model in Step3, and alternative values of the widelane ambiguities and widelane ionospheric delays corresponding to the alternative values are calculated; and
after residual examination, widelane ionospheric interpolated values of remaining unfixed baselines are calculated by means of the following formula:

$$∇ Δ {I}_{WL - IPv} = {a}_{1} \cdot Δ {X}_{v} + {a}_{2} \cdot Δ {Y}_{v} ;$$

where ΛΔI_{WL-IPv} is an unfixed double difference ionospheric delay on baseline v, ΔXᵥ and ΔYᵥ respectively represent the eastern distance and northern distance from each point of a topocentric coordinate system of baseline to the reference point, baselines with unfixed widelane ambiguities are checked and judged one by one, by taking a nearest integer of a float solution of widelane ambiguities as a center, the float solution is expanded for two or three cycles respectively toward two ends to obtain a plurality of alternative integer solutions, the alternative integer solutions are respectively substituted into Step3 to calculate corresponding widelane ionospheric delays, respectively, and when the widelane ionospheric delay of a certain alternative point meets a judgment condition in the following formula, the ambiguity is directly fixed:

$$\vert ∇ Δ {I}_{WL - IPv} - ∇ Δ {I}_{WLv} \vert < 0.3 \cdot μ ;$$

where ΛΔI_{WLv} is a double difference ionospheric delay calculated according to the alternative integer solutions.

Since μ is about 0.65 m, magnitudes of the multi-path errors and the unmolded errors in the widelane ionospheric delays are usually cm scale, so that checking is not affected. Due to the limitation to the region for use in size by this method, the ionospheric interpolation effect among the superposed pierce points is good, and the interpolation error hardly exceeds 10 cm, so that the judging correctness of the following formula is theoretically extremely high.

Step6, whether the alternative values of the widelane ambiguities calculated in Step5 meet a judgment condition is reviewed, if yes, the alternative values are added into Step3 to iteratively construct the regional ionospheric delay model, and if no, it is returned to Step5 to perform widelane ambiguity fixing calculation again.

Upon examination of all baselines in sequence, newly fixed baselines are substituted for modeling again to improve the precision of the ionospheric model. A circular process is repeated till all baselines are fixed or no new baselines are fixed.

L1 ambiguity fixing and subsequent correction number generation both are based on correct fixing of widelane ambiguities. Even if conventional widelane ambiguity resolution method may fix widelane ambiguities in enhanced positioning of the GNSS region, it cannot guarantee that all widelane ambiguities are fixed within a short time and fixed correctly; inability to fix widelane ambiguities or false fixing of widelane ambiguities will affect subsequent processing flows of all data and result in the reduced number of satellites that can be used by the correction numbers, so that the positioning effect of the user is further reduced; in combination with spatial correlation of atmospheric delays in enhanced positioning of the GNSS region, the present disclosure provides a method for network-wide fixing of widelane ambiguities based on ionospheric correlation, an apparatus, and a system. This method may calculate the corresponding ionospheric delays by means of a plurality of widelane ambiguities that have been fixed in the CORS region, and interpolates the ionospheric delays corresponding to unfixed widelane ambiguities by means of spatial correlation of the ionospheric delays, so that remaining unfixed widelane ambiguities are fixed by means of larger wavelengths widelane observed values, and whether the fixed widelane ambiguities are fixed correctly may also be checked.

An apparatus using the method for network-wide fixing of widelane ambiguities based on ionospheric correlation includes:
a determination module, configured to divide all base stations in a continuous operational reference system (CORS) network into a plurality of independent ambiguity calculation units by means of superposed ionospheric pierce points; and collect four or more groups of fixed widelane ambiguities in each of the ambiguity calculation units;
a fixing module, configured to calculate widelane ionospheric delays corresponding to each group of widelane ambiguities collected to construct a regional ionospheric delay model; judge whether the widelane ambiguities are fixed falsely according to the regional ionospheric delay model, if the widelane ambiguities are fixed falsely, eliminate the falsely fixed widelane ambiguities, judge whether no fewer than four groups of remaining widelane ambiguity data are present, and if no fewer than four groups of remaining widelane ambiguity data are present, repeatedly execute the previous step; and if fewer than four groups of remaining widelane ambiguity data are present, exit a calculation process; if no false fixing is found in a process of judging false fixing of widelane ambiguities, continuously judge whether unfixed widelane ambiguities exist in a current ambiguity calculation unit, and if the unfixed widelane ambiguities exist in the current ambiguity calculation unit, interpolate widelane ionospheric delays corresponding to the unfixed ambiguities by means of the regional ionospheric delay model, and calculate alternative values of the widelane ambiguities and widelane ionospheric delays corresponding to the alternative values; and
a modeling module, configured to view whether the alternative values calculated meet a judgment condition, if yes, iteratively construct the regional ionospheric delay model, and if no, perform widelane ambiguity fixing calculation again.

System devices using the method for network-wide fixing of widelane ambiguities based on ionospheric correlation include a processor, a memory, and a program for network-wide fixing of widelane ambiguities based on ionospheric correlation, that is, stored in the memory and executable by the processor, where when executed by the processor, the program for network-wide fixing of widelane ambiguities based on ionospheric correlation implements the steps of the method for network-wide fixing of widelane ambiguities based on ionospheric correlation.

### EMBODIMENTS

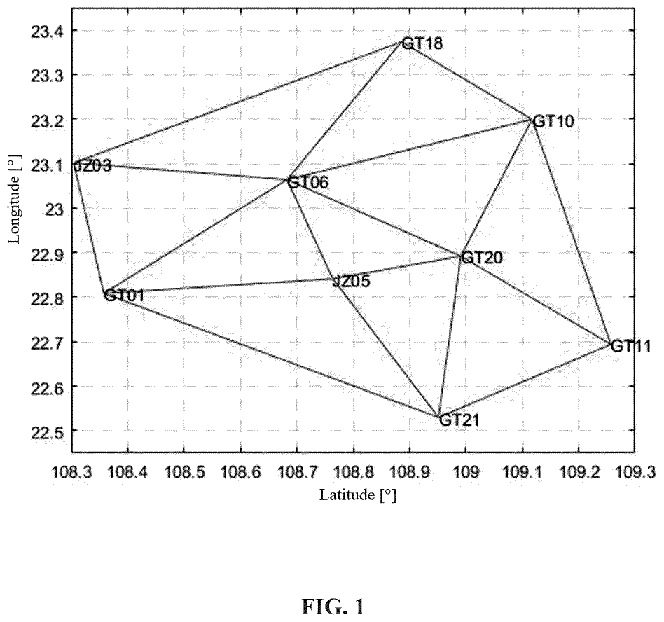

9 groups of GNSS reference station data meeting a requirement of pierce points in a CORS network somewhere are used to a low-latitude region in south China for testing, the average station spacing is 48 km, and station sites are distributed as shown in FIG. 1.

### Experiment I: Gross Error Detection and Validation

Since existing widelane ambiguity fixing methods cannot guarantee that ambiguities are correctly fixed completely. Even if widelane ambiguities are falsely fixed for one cycle, a huge error of about 0.65 m will also be generated on subsequent ionospheric delay extraction, modeling and interpolation; meanwhile, this method is used for network-wide fixing of widelane ambiguities based on spatial correlation; if no falsely fixed widelane ambiguities are detected, other unfixed widelane ambiguities in the unit will be affected severely; therefore, validation of the novel method on detection capability of gross errors is quite important.

The detection capability of the novel method is checked with the gross errors by adding one cyclic gross error into a randomly fixed widelane ambiguity in the unit, and meanwhile, in order to verify whether the data volume participating in resolution affects the detection or not, 9 base stations of CORS are selected to comparatively verify whether posterior residual errors and posterior precision check change or not when the quantity of the observed values participating in modeling is different.

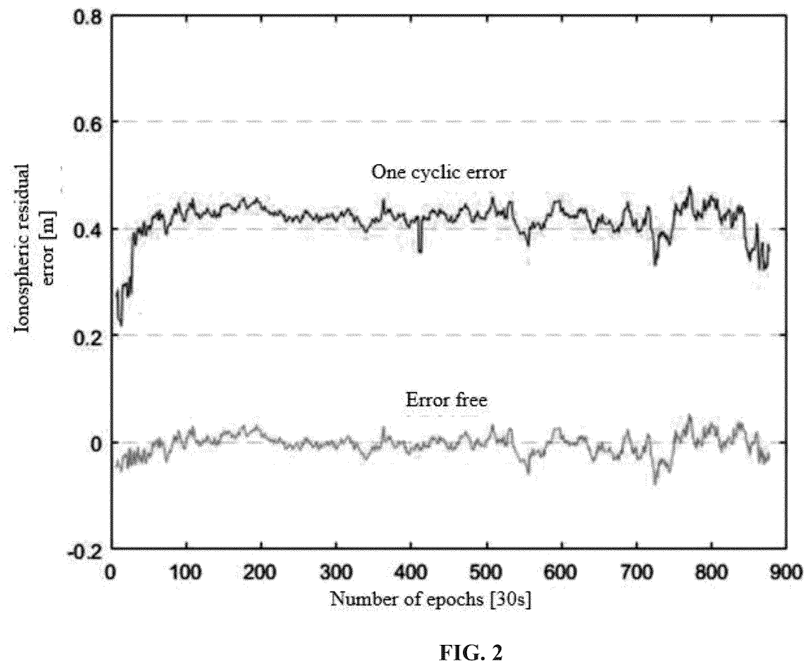

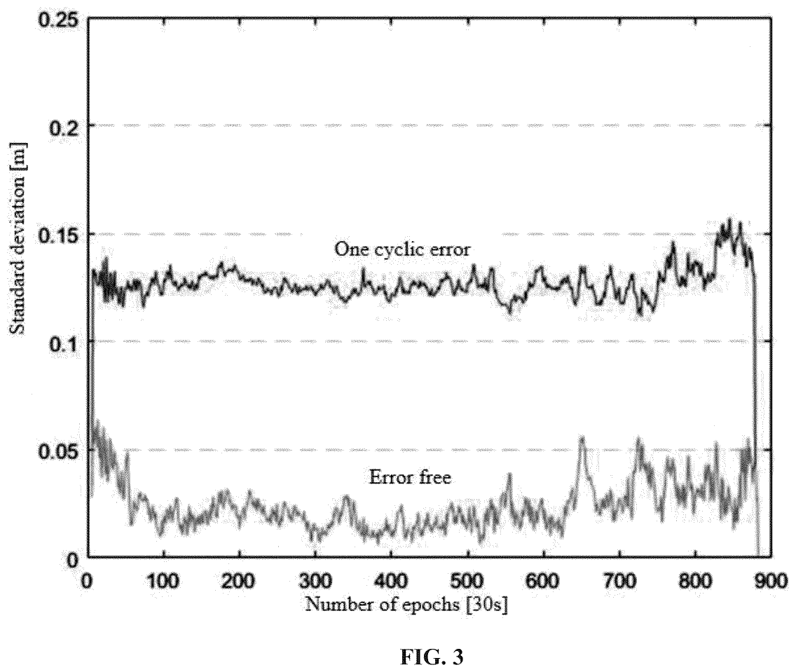

This group of experiments are verification experiments for GPS PRN06 satellites. One cyclic gross error is added into the integer solution of widelane ambiguities of GPS PRN06 of baselines GT14_GT18. It may be known from FIG. 2 and FIG. 3 that due to whole adjustment, residual errors of GPS PRN06 jump greatly to 0.4 m, which may easily detect a change induced by the gross error; the root mean square error of the network-wide widelane ionospheric layer of GPS PRN06 corresponding thereto is greatly changed from about 0.03 m to about 0.13 m, indicating a huge influence of widelane ambiguity gross error on posterior precision of the widelane ionospheric model. Declines at the front and back ends in the figures are because that GPS PRN06 of the baselines GT14_GT18 in an initial and terminal segments of a curve are not commonly viewed and do not participate in whole adjustment, so that a result with the gross error is basically consistent with a correct result.

On the whole, the average station spacing in the CORS network in China is mostly distributed within a range of 30-100 km. Therefore, the number of base stations in a single calculation unit is limited, which is almost 8-10. In combination with the above experimental results, setting the posterior residual threshold for single observed value as 0.3 times u and the integral posterior precision as 0.2 times μ may effectively judge false fixing of widelane ambiguities.

### Experiment II: Widelane Ambiguity Fixing Verification Experiment

Upon determining the detection gross error, the CORS data is resolved, and widelane ambiguities are fixed; in order to verify ambiguity fixing performance, regardless of complete fixing of widelane ambiguities in the epoch, just 4 groups of fixed widelane ambiguities are selected for network-wide fixing of widelane ambiguities based on ionospheric correlation on remaining widelane ambiguities, and information such as fixing correctness is counted by means of a posterior true value; since no correlation exists between epochs of this method, it is actually a single epoch fixing method, so that data result of each epoch may be regarded independent. Information is summarized in the following table:

TABLE 1
Information statistic table for widelane ambiguity fixing of CORS

| Elevation [°] | 0-10 | 10-20 | 20-30 | 30-40 | 40-50 | 50-60 | 60-70 | 70-90 | 0-90 |
|---|---|---|---|---|---|---|---|---|---|
| Total | 114 | 40751 | 81175 | 48651 | 73034 | 72764 | 51966 | 6960 | 375415 |
| number of | | | | | | | | | |
| epochs | | | | | | | | | |
| Number of | 113 | 40749 | 80845 | 48651 | 73034 | 72764 | 51966 | 6960 | 375082 |
| fixed | | | | | | | | | |
| epochs | | | | | | | | | |
| Number of | 0 | 0 | 0 | 0 | 0 | 0 | 0 | 0 | 0 |
| falsely | | | | | | | | | |
| estimated | | | | | | | | | |
| epochs | | | | | | | | | |
| P_{sf}[%] | 100.00 | 100.00 | 100.00 | 100.00 | 100.00 | 100.00 | 100.00 | 100.00 | 100.00 |
| Pᵤ[%] | 0.90 | 0.00 | 0.40 | 0.00 | 0.00 | 0.00 | 0.00 | 0.00 | 0.09 |
| P_{f}[%] | 0.00 | 0.00 | 0.00 | 0.00 | 0.00 | 0.00 | 0.00 | 0.00 | 0.00 |

It may be seen from the above table that the novel method provided by the present disclosure performs extremely well in terms of fixed rate and correctness. False estimation is not present in nearly four hundred thousand groups of widelane ambiguities, and this method has better detection and repair abilities for falsely fixed ambiguities in the existing widelane ambiguity fixing methods. Meanwhile, the novel method is extremely high in terms of fixed rate, which means that when widelane ambiguities of more than 4 baselines or 4 base stations have been fixed in the calculation unit, all widelane ambiguities may almost be fixed in this epoch.

### Experiment III: Positioning Verification

In order to further verify the effectiveness of the method provided by the present disclosure and improvement of maximum fixing of widelane ambiguities on the positioning effect of the user, the GT20 observation station in the CORS simulates the user. To facilitate comparison, resolution which does not use the method provided by the present disclosure is called method I, and widelane ambiguity fixing of CORS network using the method provided by the present disclosure is called method II. A moving station positioning resolution mode is unified as a dynamic single epoch ambiguity fixing mode, to exhibit the true performance of fast ambiguity fixing at the user terminal.

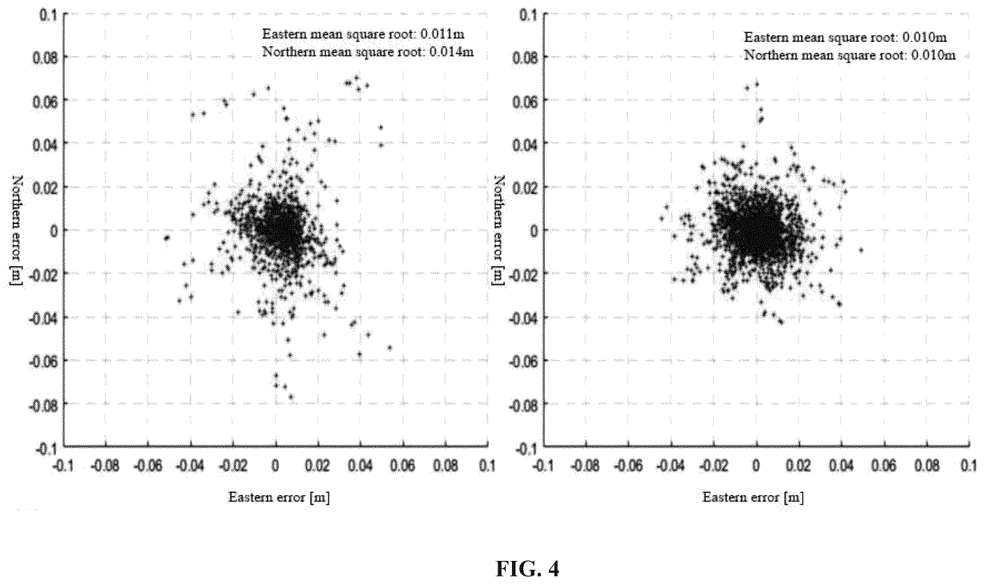

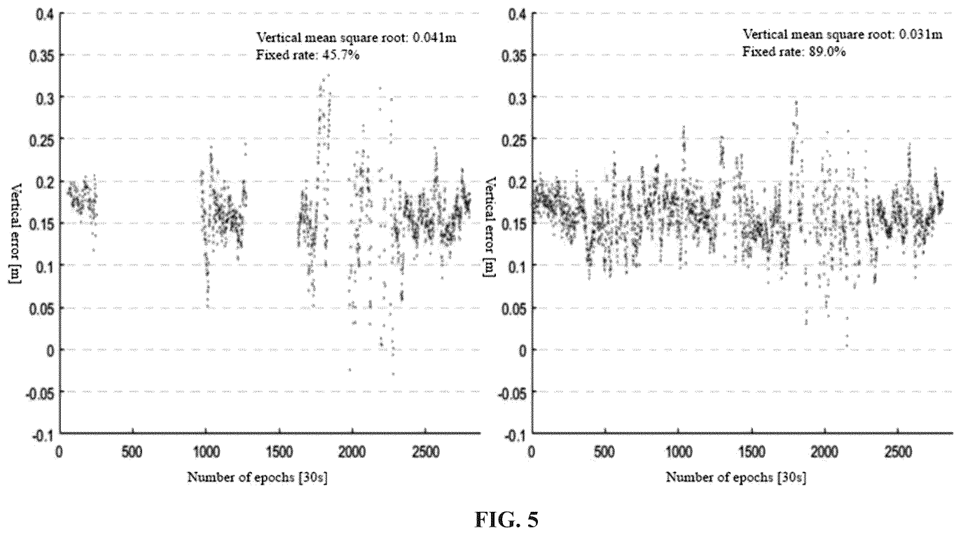

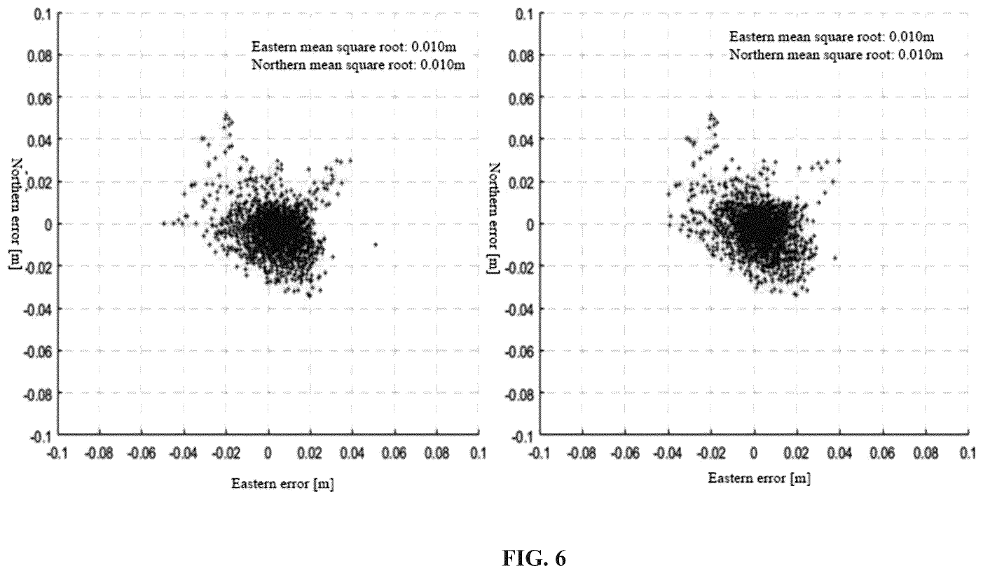

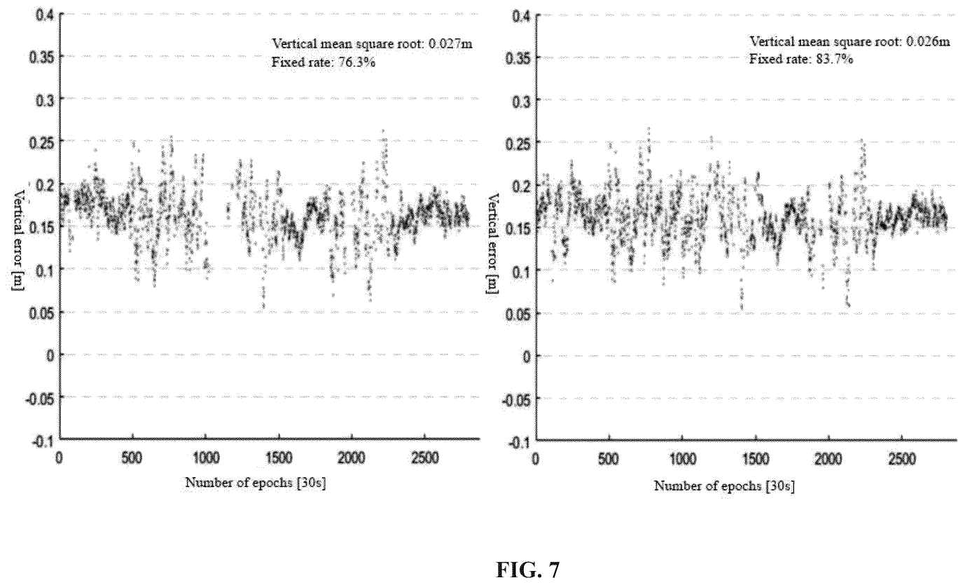

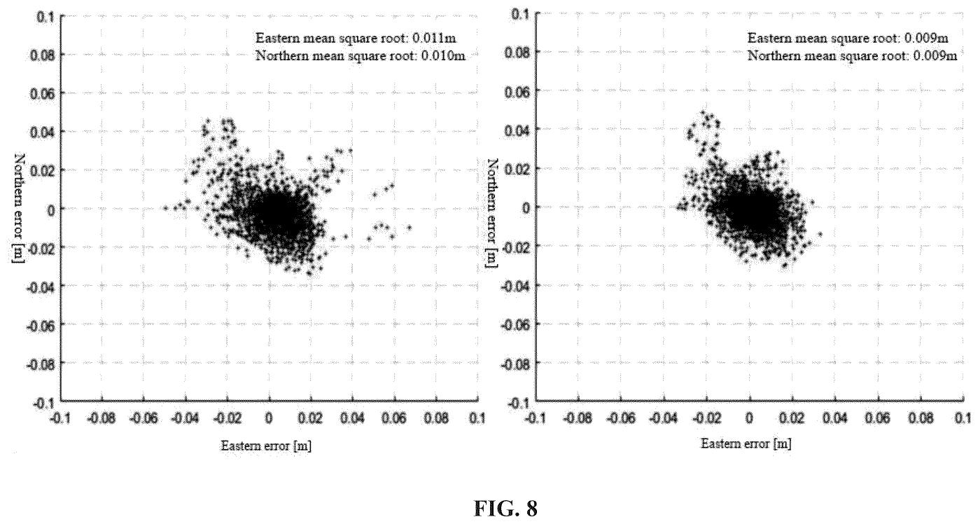

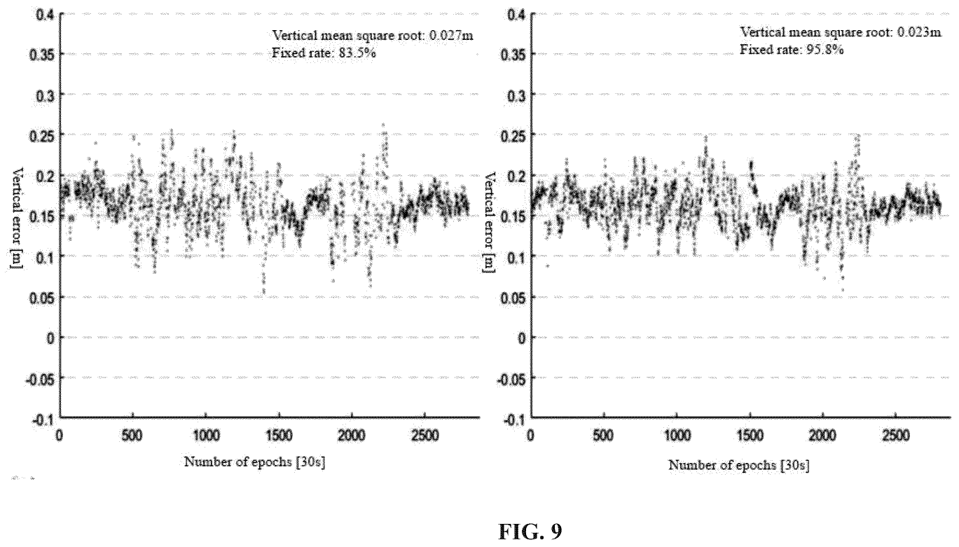

FIG. 4 to FIG. 9 are sequence charts of positioning results of single BSD, single GPS, and GPS and BDS combined GC corresponding to method I and method II; it may be seen that this method significantly improves the positioning precision and fixed rates of the three combinations, where the fixed rates of BSD, GPS, and GC are increased by 48.7%, 8.8%, and 12.8%, respectively, and the precision in the elevation direction is increased by 32.3%, 3.8%, and 17.4%, respectively; the positioning effect on the BDS system is particularly significantly improved.

In combination with the conventional method in Table 2, the correction number broadcasted by network RTK averagely has 4.4 groups of BDS observed values, which is much fewer than 6.6 groups in the method provided by the present disclosure. It may be known that this is mainly due to on-board multi-path effect of BDS, multiple paths of the pseudorange observed values of BDS are severely affected, so that the fixed rate of widelane ambiguities of BDS is further decreased.

TABLE 2
Positioning information statistics of GT20

| | | Method 1 | | | Method 2 | | |
|---|---|---|---|---|---|---|---|
| System | | BDS | GPS | GC | BDS | GPS | GC |
| Number of DD | | 4.43 | 5.29 | 9.72 | 6.64 | 6.32 | 12.97 |
| observation | | | | | | | |
| Fixed Rate % | | 45.57 | 76.32 | 83.50 | 89.00 | 83.71 | 90.55 |
| RMS | East | 0.011 | 0.010 | 0.010 | 0.010 | 0.009 | 0.010 |
| [m] | North | 0.014 | 0.010 | 0.010 | 0.010 | 0.009 | 0.010 |
| | Up | 0.041 | 0.027 | 0.031 | 0.026 | 0.023 | 0.025 |

On the whole, the novel method for widelane ambiguity fixing based on ionospheric correlation provided by the present disclosure can accurately detect falsely fixed widelane ambiguities and nearly completely fix regional widelane ambiguities correctly, thereby breaking the shackle of widelane ambiguity fixing on subsequent data processing of network RTK; the correctness of this method is verified by means of the positioning experiment, and after it is verified that the widelane ambiguities are fully correctly fixed, this method significantly improves indexes such as fixed rate and positioning precision of three combinational positioning by GPS, BDS, and GC of the user, where the BDS system is improved to the maximum extent, the fixed rate is integrally increased by about 35%, and the positioning precision in the vertical direction is increased by over 30%.

What is claimed is:

1. A method for network-wide fixing of widelane ambiguities based on ionospheric correlation, comprising the following steps:
Step 1, dividing all base stations in a continuous operational reference system (CORS) network into a plurality of independent ambiguity calculation units by means of superposed ionospheric pierce points;
Step2, collecting four or more groups of fixed widelane ambiguities in each of the ambiguity calculation units;
Step3, calculating widelane ionospheric delays corresponding to each group of widelane ambiguities collected to construct a regional ionospheric delay model;
Step4, judging whether the widelane ambiguities are fixed falsely according to the regional ionospheric delay model, if the widelane ambiguities are fixed falsely, eliminating the falsely fixed widelane ambiguities, judging whether no fewer than four groups of remaining widelane ambiguity data are present, and if no fewer than four groups of remaining widelane ambiguity data are present, repeatedly executing Step3; and if fewer than four groups of remaining widelane ambiguity data are present, exiting a calculation process;
Step5, if no false fixing is found in a process of judging false fixing of widelane ambiguities in Step4, continuously judging whether unfixed widelane ambiguities exist in a current ambiguity calculation unit, and if the unfixed widelane ambiguities exist in the current ambiguity calculation unit, interpolating widelane ionospheric delays corresponding to the unfixed ambiguities by means of the regional ionospheric delay model in Step3, and calculating alternative values of the widelane ambiguities and widelane ionospheric delays corresponding to the alternative values; and
Step6, viewing whether the alternative values of the widelane ambiguities calculated in Step5 meet a judgment condition, if yes, adding the alternative values into Step3 to iteratively construct the regional ionospheric delay model, and if no, returning to Step5 to perform calculations of fixing the widelane ambiguities gain.

2. The method for network-wide fixing of widelane ambiguities based on ionospheric correlation according to claim 1, wherein a specific process of Step1 is as follows:
a specific judgment formula for ionospheric pierce points is as follows:
$$\{ \begin{matrix}\vert {ϕ}_{{IPP}_{r}} - {ϕ}_{{IPP}_{m}} \vert < M \\ \vert \frac{{θ}_{{IPP}_{r}}}{cos {ϕ}_{{IPP}_{r}}} - \frac{{θ}_{{IPP}_{m}}}{cos {ϕ}_{{IPP}_{m}}} \vert < N\end{matrix} ; \qquad ( 1 )$$
where Ø_{IPP}_{ᵣ} and θ_{IPP}_{ᵣ} are respectively latitudes and longitudes of the ionospheric pierce points corresponding to a base station r; M and N are judgment thresholds, and by judging whether the ionospheric pierce points are superposed ionospheric pierce points, all base stations in the CORS network are divided into the plurality of independent ambiguity calculation units, ensuring that the ionospheric pierce points of each of the base stations in a same calculation unit are superposed.

3. The method for network-wide fixing of widelane ambiguities based on ionospheric correlation according to claim 2, wherein a specific process of the Step 2 is as follows:
first, attempting to perform ambiguity fixing on each satellite-base station combination in each of the ambiguity calculation units, and if ambiguities cannot be completely fixed, using a partial ambiguity fixing method to increase an ambiguity fixing quantity; then, calculating residual errors and variances of a satellite-base station observed value model with fixed ambiguities, distributing the residual errors and the variances to other variable portions containing to-be-evaluated parameters according to a law of error propagation, and taking out the residual errors and the variances of an ionospheric correlated portion; and finally, selecting the residual errors of the ionospheric portion for sequencing, and selecting widelane ambiguities with smallest variances in order for fixing, and then applying the widelane ambiguities to subsequent calculations.

4. The method for network-wide fixing of widelane ambiguities based on ionospheric correlation according to claim 3, wherein a specific process of Step3 is as follows:
first, processing baselines of the fixed widelane ambiguities to acquire approximate ionospheric delays of the baseline, extracted based on the widelane ambiguities, i.e., the widelane ionospheric delays ∇ΔI_{WL}, a calculation formula therefor being as follows:
$${λ}_{WL}^{i} ( ∇ {Δφ}_{WL , rm}^{ij} + ∇ {M}_{WL , rm}^{ij} ) = ∇ Δ {ρ}_{r m}^{ij} - \frac{{f}_{1}}{{f}_{2}} ∇ Δ I + [ ( {m}_{r}^{i} - {m}_{r}^{j} ) {T}_{r} - ( {m}_{m}^{i} - {m}_{m}^{j} ) {T}_{m} ] + ∇ Δ {γ}_{rm}^{ij} + ε ( {φ}_{r m}^{ij} ) ∇ Δ {I}_{WL} = ∇ ΔI - \frac{{f}_{2}}{{f}_{1}} [ ∇ Δ {γ}_{rm}^{ij} + ε ( {φ}_{rm}^{ij} ) ] = \frac{{f}_{2}}{{f}_{1}} \{ - {λ}_{WL}^{i} ( ∇ {Δφ}_{WL , rm}^{ij} + ∇ Δ {N}_{WL , rm}^{ij} ) + ∇ Δ {ρ}_{r m}^{ij} + [ ( {m}_{r}^{i} - {m}_{r}^{j} ) {T}_{r} - ( {m}_{m}^{i} - {m}_{m}^{j} ) {T}_{m} ] \} ; \qquad ( 2 )$$
$$where {λ}_{WL}^{i}$$
represents a double difference widelane carrier observed value;
$$∇ {Δφ}_{WL , rm}^{ij}$$
represents a double difference widelane carrier observed value;
$$∇ Δ {N}_{WL , rm}^{ij}$$
is a known double difference widelane ambiguity fixing solution;
$$∇ Δ {ρ}_{rm}^{ij}$$
is a double difference satellite-to-earth distance that is calculable; f₁ and f₂ represent a first frequency point frequency and a second frequency point frequency; ∇ΔI is a double difference ionospheric delay of a carrier observed value of L1, L1 being a first frequency point of an observed value of a GPS system;
$${m}_{r}^{i} , {m}_{r}^{j} , {m}_{m}^{i} , and {m}_{m}^{j}$$
respectively represent tropospheric projection function values of delay errors between observation stations r and m and satellites i and j; Tᵣ and Tₘ represent tropospheric delays above the observation stations r and m;
$$∇ Δ {γ}_{WL , rm}^{ij}$$
represents a delay error of double difference carrier hardware; and
$$ε ( {φ}_{rm}^{ij} )$$
represents noise of the carrier observed value; and
extracting widelane ionospheric delays corresponding to the baselines of the fixed widelane ambiguities through formula (2) to construct the regional ionospheric delay model, a formula being as follows:
$$V = BX - L ;$$
where V represents a residual matrix between the widelane ionospheric delay model and an actual observed value, B is a model design matrix, X is a to-be-evaluated model parameter matrix, L is an actual observed value matrix, ΔX₁ and ΔY₁ are an eastern distance and a northern distance from each point of a topocentric coordinate system of baseline 1 to a reference point, ΔX₂ and ΔY₂ are an eastern distance and a northern distance from each point of a topocentric coordinate system of baseline 2 to a reference point, and ΔXₙ and ΔYₙ are an eastern distance and a northern distance from each point of a topocentric coordinate system of baseline n to a reference point, meeting:
$$B = [ \begin{matrix}Δ {X}_{1} & Δ {Y}_{1} \\ Δ {X}_{2} & Δ {Y}_{2} \\ ⋮ & ⋮ \\ Δ {X}_{n} & Δ {Y}_{n}\end{matrix} ] ; X = [ \begin{matrix}{a}_{1} \\ {a}_{2}\end{matrix} ] ;$$
where a₁ and a₂ are corresponding interpolation coefficients; and
$$L = [ \begin{matrix}∇ Δ {I}_{WL 1} \\ ∇ Δ {I}_{WL 2} \\ ⋮ \\ ∇ Δ {I}_{WL n}\end{matrix} ] .$$

5. The method for network-wide fixing of widelane ambiguities based on ionospheric correlation according to claim 4, wherein a specific process of Step4 is as follows:
upon completion of constructing the regional ionospheric delay model, due to redundant observations, checking the residual errors of the observed value model, checking indexes being as follows:
$$\{ \begin{matrix}\vert {V}_{i} \vert < 0.3 \cdot μ & i = 1 , 2 , … n \\ \sqrt{\frac{{V}^{T} \cdot V}{n}} < 0.2 \cdot μ & \end{matrix}$$
$$μ = {λ}_{W L} \cdot \frac{{f}_{2}}{{f}_{1}} ;$$
where Vᵢ represents an i^{th} residual error, λ_{WL} represents a wavelength of the widelane carrier observed value, V^{T} is a transposed vector of the residual matrix, and μ is a widelane ionospheric delay variation induced by false fixing of the widelane ambiguity or one cycle, and is derivable from the formula in Step3; and
if the residual errors exceed a limit, eliminating a maximum value of the residual errors, performing remodeling till residual checking passes or fewer than four available baselines are present.

6. The method for network-wide fixing of widelane ambiguities based on ionospheric correlation according to claim 5, wherein in Step5, after residual checking, widelane ionospheric interpolated values of remaining unfixed baselines are calculated by means of the following formula:
$$∇ Δ {I}_{WL - IPv} = {a}_{1} \cdot Δ {X}_{v} + {a}_{2} \cdot Δ {Y}_{v} ;$$
where ∇ΔI_{WL-IPv} is an unfixed double difference ionospheric delay on baseline v, ΔXᵥ and ΔYᵥ respectively represent the eastern distance and northern distance from each point of a topocentric coordinate system of baseline v to the reference point, baselines with unfixed widelane ambiguities are checked and judged one by one, by taking a nearest integer of a float solution of widelane ambiguities as a center, the float solution is expanded for two or three cycles respectively toward two ends to obtain a plurality of alternative integer solutions, the alternative integer solutions are respectively substituted into Step3 to calculate corresponding widelane ionospheric delays, respectively, and when the widelane ionospheric delay of a certain alternative point meets a judgment condition in the following formula, the ambiguity is directly fixed:
$$\vert ∇ Δ {I}_{WL - IPv} - ∇ Δ {I}_{WLv} \vert < 0.3 \cdot μ ;$$
where ΛΔI_{WLv} is a double difference ionospheric delay calculated according to the alternative integer solutions.

7. The method for network-wide fixing of widelane ambiguities based on ionospheric correlation according to claim 6, wherein in Step6, ionospheric delay observed values with fixed widelane ambiguities of all station sites in a current epoch are collected, and model calculated values of the regional ionospheric delay model at the observation sites are calculated, an error mean value and a standard difference of a current model are calculated by means of a difference value between the output results after model calculation and the observed values, then, when the alternative values meet the judgment condition, first, ionospheric delay values of regions where the alternative values are located are calculated by using the existing regional ionospheric delay model, and finally, whether a difference value between the alternative values and a regional ionospheric delay model value is less than three times of the standard difference is judged, if yes, the regional ionospheric delay model is iteratively constructed, and if no, it is returned to Step5 to perform widelane ambiguity fixing calculation again.

8. The method for network-wide fixing of widelane ambiguities based on ionospheric correlation according to claim 7, wherein after Step6 is completed, with satellite motions, existing independent ambiguity calculation units will change, and when two independent ambiguity calculation units are mutually fused or pierce points in one independent ambiguity calculation unit no longer meet a limiting condition in Step1 and are split, an iterative regional ionospheric delay model should be calculated again according to Step1-Step6 by using the existing ionospheric delay model.
